(19) United States
(12) Patent Application Publication
(10) Pub. No.: US 2024/0185250 A1
(43) Pub. Date: Jun. 6, 2024

(54) COMPUTERIZED-METHOD AND COMPUTERIZED-SYSTEM FOR GENERATING A CLASSIFICATION MACHINE LEARNING MODEL FOR IMPLEMENTATION WITH NO TRAINING REQUIREMENT

(71) Applicant: Actimize Ltd., Ra'anana (IL)

(72) Inventors: Sunny THOLAR, Pune (IN); Danny Butvinik, Haifa (IL); Yonit Marcus, Rehovot (IL)

(21) Appl. No.: 18/075,445

(22) Filed: Dec. 6, 2022

(51) Int. Cl. G06Q 20/40

(52) U.S. Cl. CPC G06Q 20/4016

(57) ABSTRACT

A computerized-method for generating a classification Machine Learning (ML) model, in a cloud-based environment, is provided herein. The computerized-method includes building an ML model by using different isolated datasets from different environments: (i) identifying tenants of a service-provider by a base-activity; (ii) retrieving a set of features of objects from a database of each identified tenants to detect common features; (iii) using an object storage service in each tenant's environment to retrieve a dataset having the detected common features; (iv) training a ML model to classify objects on each retrieved dataset corresponding to a tenant from the tenants. The training of the ML model is a continuous training where the ML model continues training after each dataset, and then deploying a trained ML model in a target tenant system to classify objects. The target tenant system has no training dataset and no feasible training thereon.

### TECHNICAL FIELD

The present disclosure relates to the field of Artificial Intelligence (AI) based systems and collective Machine Learning (ML) models within financial crime.

### BACKGROUND

There are situations where a system that receives a service from a cloud service provider, don't have enough historical data that can be used as a dataset for building and training an adjusted Machine Learning (ML) model. For example, an existing Financial Institution (FI) client of a software supplier, that would like to add a new product or a new feature.

Therefore, it may take a long period of time to create an adjusted ML model on the client data, because it takes 6-9 months for client data to get mature. Accordingly, there is a need for a technical solution for generating a day one out of the box classification ML model that can be used by new tenants of a cloud service provider, that the ML model was never trained on a new tenant related dataset before.

There is a need for a system and method for a ML model for a new tenant having a new financial product that is still not covered by an effective ML model by generating a classification ML model, by using different isolated datasets from different environments in a cloud-based environment, such as contact center for deployment in new tenants systems.

### SUMMARY

There is thus provided, in accordance with some embodiments of the present disclosure, a computerized-method for generating a classification Machine Learning (ML) model, in a cloud-based environment.

In accordance with some embodiments of the present disclosure, the computerized-method may include building a ML model by using different isolated datasets from different environments. Building the ML model may include: (i) identifying one or more tenants of a service provider by a base activity; (ii) retrieving a set of features of objects from a database of each identified one or more tenants to detect one or more common features; (iii) using an object storage service in each tenant's environment to retrieve a dataset having the detected one or more common features; and (iv) training a ML model to classify objects on each retrieved dataset corresponding to a tenant from the one or more tenants. The training of the ML model may be a continuous training where the ML model continues training after each dataset.

Furthermore, in accordance with some embodiments of the present disclosure, the computerized-method may further include deploying a trained ML model in a target tenant system to classify objects. The target tenant system has no training dataset and no feasible training thereon. The classified objects are for the base activity and having features which have been used for training the ML model.

Furthermore, in accordance with some embodiments of the present disclosure, when the target tenant system has accumulated a preconfigured amount of historical data, training the ML model on the historical data.

Furthermore, in accordance with some embodiments of the present disclosure, the detecting of common one or more features may include: (i) running feature engineering and feature selection pipeline on each tenant dataset to yield features scores. A feature score indicates a level of relevance of a feature to a classification of objects by the classification ML model; and (ii) identifying a preconfigured number of high scores features across each one or more tenants.

Furthermore, in accordance with some embodiments of the present disclosure, the features scores may be yielded by an extreme Gradient Boosting (XGB) algorithm.

Furthermore, in accordance with some embodiments of the present disclosure, the classification ML model may be fraud detection ML model and the objects may be transactions. The transactions may be classified by the classification ML model as fraud or non-fraud.

Furthermore, in accordance with some embodiments of the present disclosure, the training of the ML model may be performed by operating an extreme Gradient Boosting (XGB) algorithm.

Furthermore, in accordance with some embodiments of the present disclosure, the retrieved dataset may include detected one or more common features of transactions from a preconfigured period.

Furthermore, in accordance with some embodiments of the present disclosure, the retrieved dataset having the detected one or more common features is a labeled dataset.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a high-level diagram of a computerized-system for generating a classification model for implementation with no training requirement, in accordance with some embodiments of the present invention;

FIGS. 2A-2B is a schematic flowchart of an operation of generating a classification Machine Learning (ML) model in a cloud-based environment, in accordance with some embodiments of the present invention;

FIG. 3 is an example of a table of financial tabular data, in accordance with some embodiments of the present invention;

FIG. 4 schematically illustrates a high-level diagram of a classification Machine Learning (ML) model generation in a cloud-based environment, in accordance with some embodiments of the present invention;

FIG. 5 is diagram which illustrates a common information model procedure, in accordance with some embodiments of the present invention;

FIG. 6 is a workflow of one or more common feature selection, in accordance with some embodiments of the present invention;

FIG. 7 is a workflow of dataset preparation for model training, in accordance with some embodiments of the present invention;

FIG. 8 is a workflow of generating a classification Machine Learning (ML) model, in a cloud-based environment, in accordance with some embodiments of the present invention;

FIG. 9 shows a graph illustrating evaluation and results, in accordance with some embodiments of the present invention;

FIG. 10 shows a graph illustrating evaluation and results, in accordance with some embodiments of the present invention; and

FIG. 11 is a high-level process flow diagram of a system, in accordance with some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The terms “Machine Learning model” and “classification ML model may be interchangeable.

The term transaction as used herein refers to a financial transaction.

Artificial Intelligence (AI)-based system is a computer system that is able to perform tasks that ordinarily require human intelligence. Many of these AI systems are powered by rules-based Machine Learning (ML) models and some of them are powered by deep learning.

Traditional classical Machine Learning (ML) models are training on static historical data in a batch setting, however, current technical solutions encounter data privacy issues in financial domain, since data of one bank may not be shared with another bank.

Accordingly, there is a need for a technical solution whereby the ML model may be fitted to a combined dataset from all the sites or environments, such as banks, in one go.

Accordingly, there is a need for a technical solution to overcome this problem to avoid data sharing between banks by a collective ML paradigm for classification such as fraud detection.

Therefore, there is a need for a system and method for generating a classification Machine Learning (ML) model, in a cloud-based environment

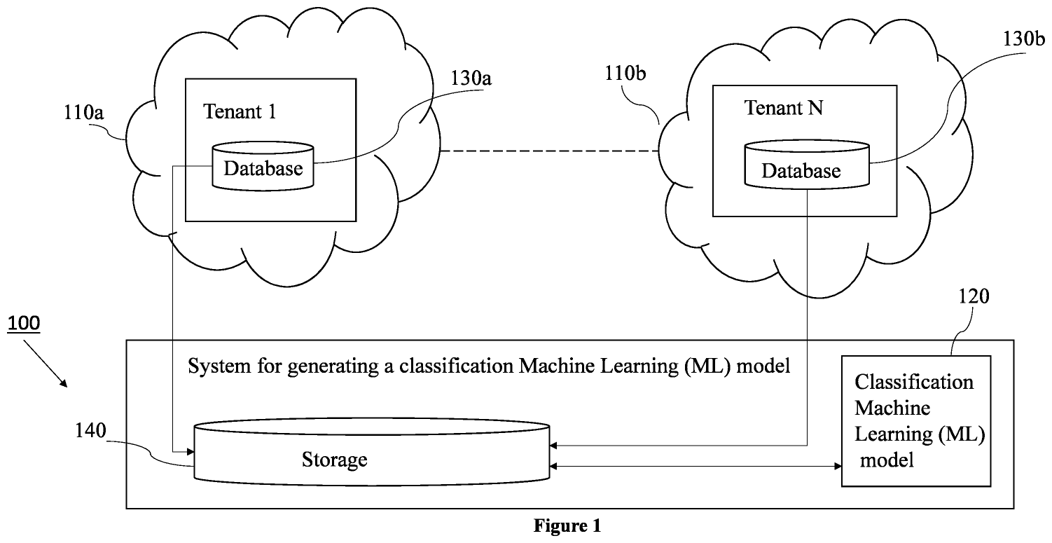

FIG. 1 schematically illustrates a high-level diagram of a computerized-system 100 for generating a classification model for implementation with no training requirement, in accordance with some embodiments of the present invention.

According to some embodiments of the present disclosure, a system, such as computerized-system 100 may use a collective intelligence ML model, to overcome privacy issues that may arise when data of one bank is shared with another bank. The collective intelligence ML model may be continuously trained on a dataset from one bank at a time. Thus, during training, the ML model, such as classification ML model 120, may be trained first only on a dataset from Bank-1, e.g., ‘tenant 1’ 110a and then it may start training on a dataset from a second tenant, e.g., Bank-2, from where it has stopped training on Bank-1.

According to some embodiments of the present disclosure, the training process may continue in the same manner on datasets of the tenants, e.g., banks. Thus, data sharing among different tenants may not be required, instead only the ML model object may be shared across different tenants and the ML model may be trained on top of it.

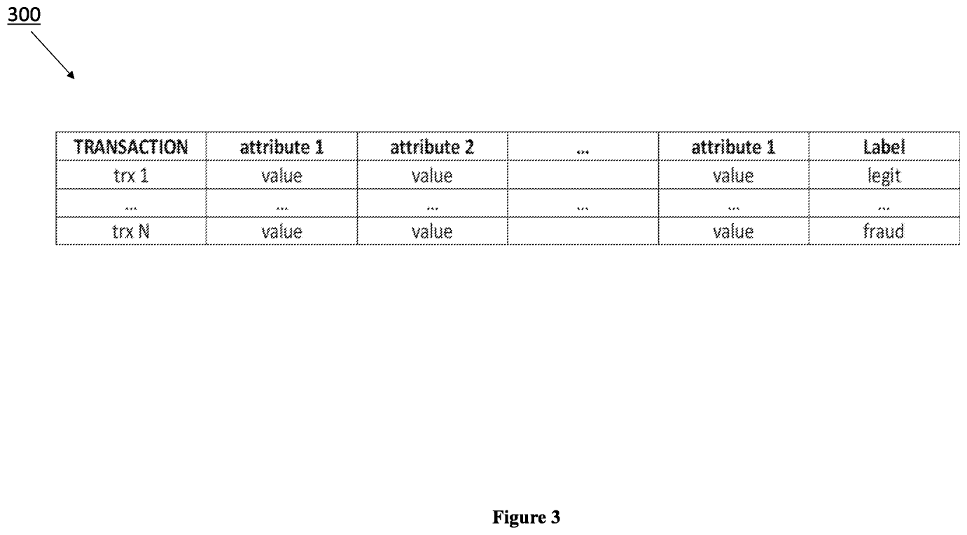

According to some embodiments of the present disclosure, the dataset from each tenant may be labeled and may be maintained in a tabular data format, as shown in table 300 in FIG. 3, where each transaction has its label based on previous investigations from the past by the financial institution. A typical transaction consists of various features, i.e., attributes, that are heterogeneous by its nature: numerical, categorical, ordinal etc.

According to some embodiments of the present disclosure, in situations, where a tenant don't have enough historical data that can be used for building and training a tailored ML model, or alternatively, an existing tenant, such as a Financial Institution (FI) client who comes up with a new product, it may take too long to create a tailored ML model on their data, because it takes 6-9 months for the data to get matured. Limitations of data is a known problem in financial domain which confines generation of a robust and effective machine leaning model.

According to some embodiments of the present disclosure, system 100 may generate a classification ML model, in a cloud-based environment, by using different isolated datasets from different environments to build and train the classification ML model 120.

According to some embodiments of the present disclosure, a model, such as classification ML model 120, may be trained continuously across different datasets from different tenants using ML models. For example, XGBoost (XGB) algorithm provides a mechanism to train the ML model continuously.

According to some embodiments of the present disclosure, activities are a way to logically group together events that occur in a client's systems, e.g., bank system that received cloud-based service. Each communication channel may be an activity, such as, web activity. Each type of service may be an activity, for example, internal transfer activity. Each combination of an activity and a type of service is an activity, for example, web internal transfer activity.

According to some embodiments of the present disclosure, activities may span multiple channels and services, for example, transfer activity, which is any activity that results in a transfer. Transactions can be associated with multiple activities.

According to some embodiments of the present disclosure, one or more tenants of a service provider, e.g., 110a through 110b may be identified by a base activity. Activities are divided into multiple base activities. Base activity may be a specific transaction type or an event type. For example, wire received from a mobile app may be classified as M_EDT base activity, while Automated Clearing House (ACH) payment received from a web app may be classified as another base activity such as W_ACH.

According to some embodiments of the present disclosure, base activities represent the most specific activity a customer of a tenant performed and determine which detection models are calculated for a transaction, i.e., specific transaction type or event type. Each transaction may be mapped to one and only one base activity.

According to some embodiments of the present disclosure, a base activity may be calculated for each transaction in a dataset. It may include the channel via which the transaction has been conducted and the transaction type as mapped in data integration. The definition of some base activities may be based on a few more attributes or the value of an additional field or a calculated indicator.

According to some embodiments of the present disclosure, data from different tenants, e.g., 110a through 110b, such as financial institutions, may be taken to identify one or more tenants of a service provider by a base activity and then a set of features of objects may be retrieved from a database of each identified one or more tenants to detect or identify one or more common features. All the common features should be available at all trained tenants.

According to some embodiments of the present disclosure, the detecting of the one or more common features may include: (i) running feature engineering and feature selection pipeline on each tenant dataset to yield features scores. A feature score indicates a level of relevance of a feature to the classification of objects by the classification ML model; and (ii) identifying a preconfigured number of high scores features across each one or more tenants.

According to some embodiments of the present disclosure, optionally, during the detection of the common features, data issues may be settled. For example, excluding all key fields, such as party-key, excluding all scrambled fields, and the like.

According to some embodiments of the present disclosure, the features scores may be yielded by an extreme Gradient Boosting (XGB) algorithm.

According to some embodiments of the present disclosure, an object storage service, e.g., 130a, 130b in each tenant's environment, may be used to retrieve a dataset having the detected one or more common features, i.e., all the common features. For example, each retrieved dataset having the detected one or more common features is of transactions from a preconfigured period. The retrieved dataset is a labeled dataset, as shown in table 300 in FIG. 3.

According to some embodiments of the present disclosure, there are factors which might impact the quality of the retrieved dataset. For example, partial data when a provided fraud report is based on one system, but the client is using few other systems to monitor fraud data, only alerted transactions were included with no missing fraud then in such as case, the ability of the tuned model to learn from the current model's weakness may be impacted, wrong fraud tagging done by the fraud investigators and the like.

According to some embodiments of the present disclosure, to improve the quality of the retrieved dataset, a fraud enrichment may be operated before the training begins. The purpose of the fraud enrichment may be to: increase the volume of the fraudulent dataset by adding more samples to learn from, lower the risk of wrongly categorizing fraudulent transactions as ‘Clean’ and vice versa, used as a tool to review the quality of the fraudulent dataset, if the number of enriched transactions is relatively high, then it is suspicious. There are basic fraud enrichment criteria, such as same party, same payee, same device, same payee and other parties.

According to some embodiments of the present disclosure, the fraud enrichment may be operated for both training and test datasets.

According to some embodiments of the present disclosure, a ML model, such as classification ML model 120, may be trained to classify objects on each retrieved dataset corresponding to a tenant from the one or more tenants. The training of the ML model is a continuous training where the ML model continues training after each dataset. For example, training the ML model in the environment of ‘tenant 1’ 110a on a dataset taken from ‘tenant 1’, and then sending the object of the ML model for continuing training in the environment of ‘tenant 2’ on a dataset taken from ‘tenant 2’ and so on until training in the environment of ‘tenant N’ on a dataset taken from ‘tenant N’. The continuous training of the ML model may be operated on all datasets of all identified one or more tenants, to yield a final ML model.

According to some embodiments of the present disclosure, a trained ML mode, e.g., a final ML model may be deployed at a target tenant system, for example, a financial institution, right from the start. The trained ML model may be deployed in a target tenant system to classify objects, where the target tenant system has no training dataset and no feasible training thereon.

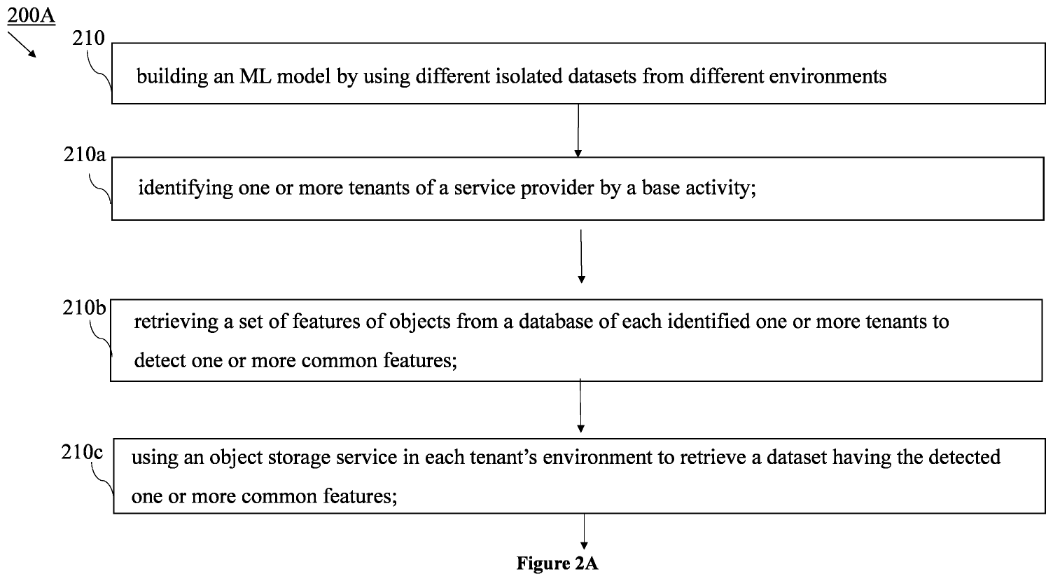

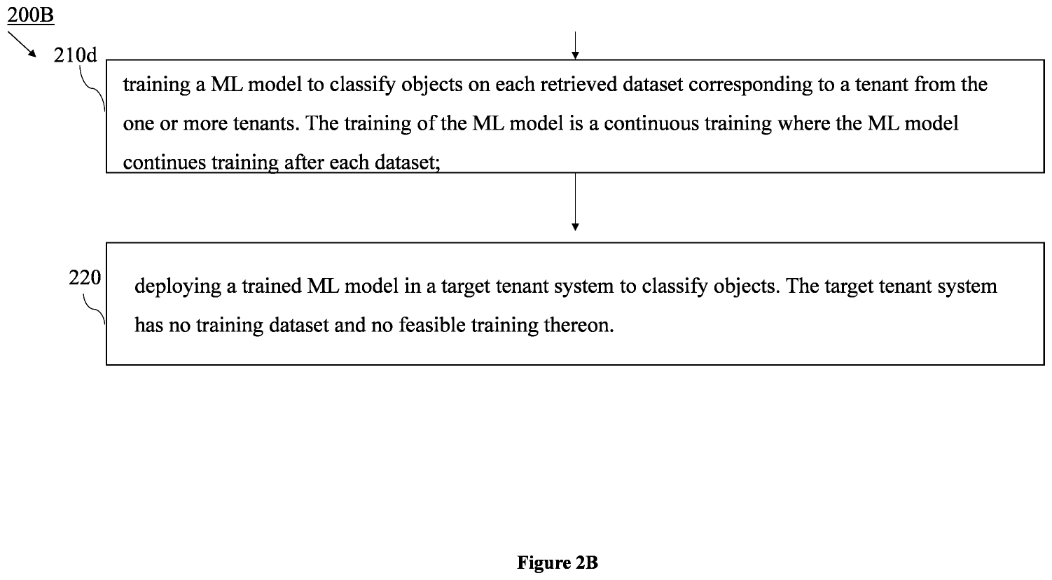

FIGS. 2A-2B is a schematic flowchart of an operation 200 of generating a classification model for implementation with no training requirement, in accordance with some embodiments of the present invention.

According to some embodiments of the present disclosure, operation 210 comprising building an ML model by using different isolated datasets from different environments. Operation 210 may include operations 210a-210d.

According to some embodiments of the present disclosure, operation 210a comprising identifying one or more tenants of a service provider by a base activity.

According to some embodiments of the present disclosure, operation 210b comprising retrieving a set of features of objects from a database of each identified one or more tenants to detect one or more common features.

According to some embodiments of the present disclosure, operation 210c comprising using an object storage service in each tenant's environment to retrieve a dataset having the detected one or more common features.

According to some embodiments of the present disclosure, operation 210d comprising training a ML model to classify objects on each retrieved dataset corresponding to a tenant from the one or more tenants. The training of the ML model is a continuous training where the ML model continues training after each dataset.

According to some embodiments of the present disclosure, operation 220 comprising deploying a trained ML model in a target tenant system to classify objects. The target tenant system has no training dataset and no feasible training thereon.

FIG. 3 is an example of a table 300 financial tabular data, in accordance with some embodiments of the present invention.

According to some embodiments of the present disclosure, a system, such as computerized-system 100 in FIG. 1, may retrieve a set of features of objects from a database of each identified one or more tenants to detect one or more common features. The detected features may be stored in a storage such as storage 140, for example, in a file format, such as Comma-Separated Values (CSV) file.

According to some embodiments of the present disclosure, an object storage service e.g., database 130a and database 130b, may be further used to retrieve a dataset having the detected one or more common features in each tenants environment. The retrieved dataset may be used for training a ML model, such as classification ML model 120, in each tenants environment.

According to some embodiments of the present disclosure, the dataset may be labeled in a tabular format where each transaction has its label based on previous investigations from the past by the financial institution. A typical transaction includes various attributes that are heterogeneous by its nature: numerical, categorical, ordinal etc.

According to some embodiments of the present disclosure, table 300 is an example of financial tabular data that includes different transactions with related features, i.e., attributes. For example, amount of transferred money, payer name, payor name, payer address, payor address, bank name, device type, geolocation etc.

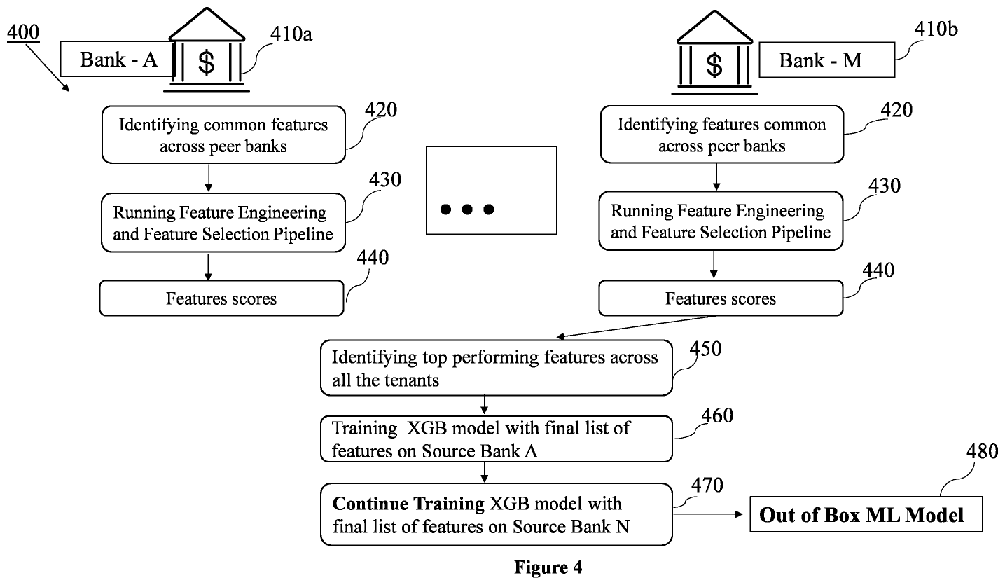

FIG. 4 schematically illustrates a high-level diagram 400 of a classification Machine Learning (ML) model generation in a cloud-based environment, in accordance with some embodiments of the present invention.

According to some embodiments of the present disclosure, in a system, such as system 100 in FIG. 1, may identify one or more tenants of a service provider by a base activity. For example, bank-A 410a through bank-M 410b.

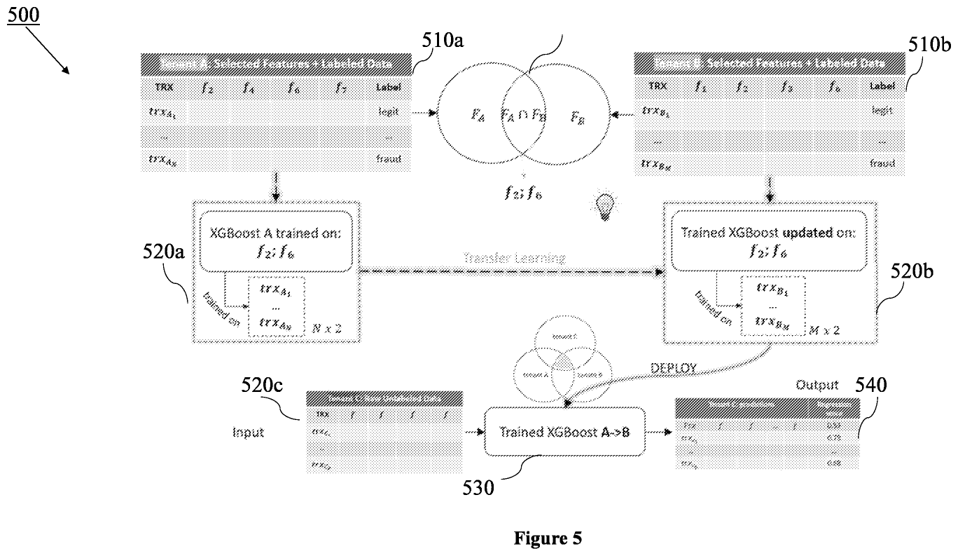

According to some embodiments of the present disclosure, the system may further identify common features across peer banks by retrieving a set of features of objects from a database of each identified one or more tenants to detect one or more common features, as shown for example in diagram 500 in FIG. 5.

According to some embodiments of the present disclosure, the detection of one or more common features may include running feature engineering and feature selection pipeline 430 on each tenant dataset to yield features scores 440. A feature score may indicate a level of relevance of the feature to the classification of the objects by the classification ML model, such as classification ML model 120 in FIG. 1.

According to some embodiments of the present disclosure, the system may further identify top performing features across all the tenants 450, by identifying a preconfigured number of high scores features across each one or more tenants.

According to some embodiments of the present disclosure, the system may further train a ML model, such as classification ML model 120 in FIG. 1, to classify objects on each retrieved dataset corresponding to a tenant from the one or more tenants, for example by training XGB model with the final list of features, i.e., common one or more features on source Bank-A 460 and then continue training the XGB model with the final list of features on the next source bank and so on until continue training the XGB model with the final list of features on the next source bank-N 470 to yield a trained ML model.

According to some embodiments of the present disclosure, the training of the ML model is a continuous training where the ML model continues training after each dataset.

According to some embodiments of the present disclosure, the trained ML model may be deployed as an out of the box ML model 480 in a target tenant system to classify objects, where the target tenant system has no training dataset and no feasible training thereon.

FIG. 5 is diagram 500 which illustrates a common information model procedure, in accordance with some embodiments of the present invention.

According to some embodiments of the present disclosure, a system, such as system 100 in FIG. 1, may identify one or more tenants of a service provider by a base activity, such as tenant A 510a and tenant B 510b. One or more common features, such as features f₂ and f₆, may be detected and then a training model, such as XGboost, may operate in the environment of tenant A 510a on a dataset that is retrieved from a database of tenant A, such as database 130a, in FIG. 1, that includes the detected one or more features f₂ and f₆ to build and train a ML model. The retrieved dataset having the detected one or more common features f₂ and f₆ may be of transactions from a preconfigured period.

According to some embodiments of the present disclosure, a transfer learning may be operated by sending an object of the trained ML model to an environment of tenant B 510b. The object may be trained by a training model, such as XGboost on a dataset retrieved from tenant B 510b and including the detected one or more features f₂ and f₆.

According to some embodiments of the present disclosure, deploying the trained ML model, such as trained XGBoost A->B 530 in a target tenant system to classify objects, e.g., transactions. The transactions to be classified may be provided in a dataset of the target tenant 520c, where the dataset may include transactions having the one or more common features to tenant A 510a and tenant B 510b.

According to some embodiments of the present disclosure, the output of the trained ML model, such as trained XGBoost A->B 530 may be a risk score, such as a regression score.

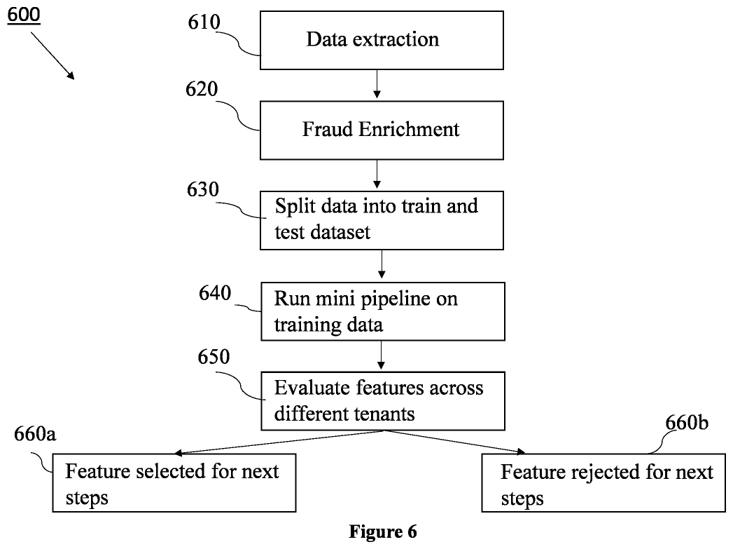

FIG. 6 is a workflow 600 of one or more common feature selection, in accordance with some embodiments of the present invention.

According to some embodiments of the present disclosure, in a system, such as system 100 in FIG. 1, data extraction 610 may be operated. The data may be extracted for 3-6 months from each tenant, such as financial institution database among different banks that share a common data trait, i.e., having similar base activity. Base activities are a way to logically group together events that occur in the client's systems for profiling and detection purposes. for example, commercial international wire transfer via Offline channel. The data may include a set of features of objects, such as transactions from each database, such as databases 130a and 130b in FIG. 1, to detect one or more common features.

According to some embodiments of the present disclosure, the features that were considered for the ML model inclusion. e.g., one or more common features, consisted of all features available to the detection process at the time of execution. This includes a variety of features describing the transaction and the party initiating the transaction. It also includes session information describing the connecting device and connection pathway, as well as the sequencing of the transaction in the current session.

According to some embodiments of the present disclosure, optionally, the system may further include fraud enrichment 620. The data enrichment is about gathering extra information based on a few data points. Similarly, Fraud enrichment is about gathering extra fraud labels from the information present for other fraud transactions. This is done by correcting some labels that there is a reason to believe the analysts, e.g., bank's analysts, have mistakenly tagged as legit instead of fraud.

According to some embodiments of the present disclosure, some assumptions may be considered when operating fraud enrichment. For example, all the legit transactions were marked as enriched fraud which was initiated +/−1 day from same device key, all the legit transactions for a payee entity have been marked as enriched fraud if there was any fraud transaction corresponding to same payee entity, and all the legit transactions for a party have been marked as fraud if there were any fraud transactions initiated from same device key for the same party key.

According to some embodiments of the present disclosure, optionally, the system may further include split data into train and test set 630. Commonly, the approach used to create train and test samples in the financial domain are using a dataset which is a subset part of the population that represents the different entities. Due to the sparsity of the fraud transactions, we usually keep all the fraudulent observations while sampling only from legit transactions. In a dataset, training set that is used to build up a ML model, while a test set is used to validate the ML model built. Data points in the training set are excluded from test set. Usually, a sampled dataset is divided into a training set and a test set.

According to some embodiments of the present disclosure, in ML paradigm, a ML model is built to predict the test data. Therefore, the training data is used to fit the ML model and the testing data to test it. The ML models which are generated are to predict results unknown, which is named as the test set. The dataset is divided into train and test set in order to check accuracies, precisions by training and testing it on it.

According to some embodiments of the present disclosure, the data may be split into 80% (train set) and 20% (test set), where the train has to be chronologically before the test to avoid data leakage.

According to some embodiments of the present disclosure, optionally, the system may run mini pipeline on training data 640. The pipeline may run on training data of each tenant. The pipeline may consist of steps like removing duplicate columns, high cardinal columns, NULL and zero variance columns. After running this pipeline preconfigured percentage, e.g., 70% of irrelevant features may be removed and will only relevant features may be left.

According to some embodiments of the present disclosure, optionally, the system may evaluate features across different tenant 650. The feature which are consistently populated across different tenants, may be looked for, e.g., features are populated at least in 3 tenants out of 4. Based on the analysis either selecting the feature to go in the next steps or dropping the feature to arrive at a final set of features which may be used in next steps, i.e., feature engineering, feature selection and collective intelligence ML model training.

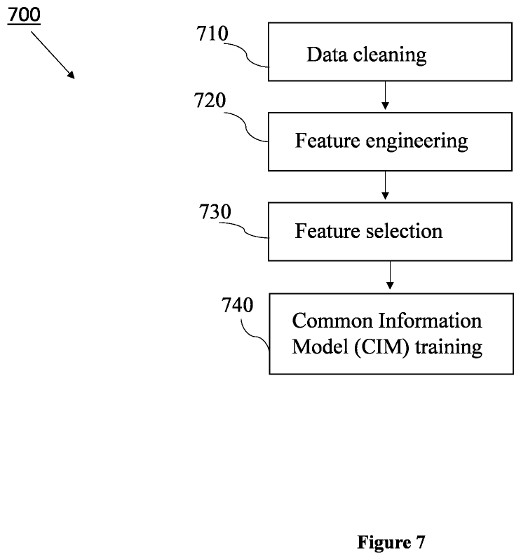

FIG. 7 is a workflow 700 of dataset preparation for model training, in accordance with some embodiments of the present invention.

According to some embodiments of the present disclosure, optionally, a system, such as system 100 in FIG. 1 may include data cleaning 710. The data cleaning is a critically important step in any machine learning project. Data cleaning refers to identifying and correcting errors in the dataset that may negatively impact a predictive model. These includes removing features that will not add any value to the model. Cleaning the data includes removing null columns, correlated columns, duplicate rows & filling missing values. Features that are uniformly missing, and zero-variance features i.e., features that are uniformly stuck at a single value, do not add any value and are removed. Highly correlated features are removed by calculating Pearson correlation coefficients between the pairs of transformed features and determining which features to eliminate.

According to some embodiments of the present disclosure, optionally, a system, such as system 100 in FIG. 1 may include feature engineering 720. Feature engineering is the process of using domain knowledge to extract features from raw data. New features may be created from the flat data, for example, date features are transformed into month, day and hour features and we add features based on business logic, such as the first and last digits of each transaction amount. Categorical features are encoded into frequency-based features based on below types of encoding, (a) one-hot encoding, which reduces each categorical value to a separate Boolean variable, based on whether the variable contains that value or not (b)lift-based encoding, where each category is assigned, a numeric value based on its relative propensity to identify fraud (c) population-based encoding, where each category is assigned, a numeric value based on its relative frequency in the underlying population.

The number of the features should be controlled to avoid dimensionality, therefore, a maximum number for common features may be configured.

According to some embodiments of the present disclosure, optionally, a system, such as system 100 in FIG. 1 may include feature selection 730. Feature selection improves the ML process and increases the predictive power of ML algorithms by selecting the most important variables and eliminating redundant and irrelevant features. After the feature engineering is performed, feature score for each feature may be generated using ML technique across all the tenants. Then, features may be ranked, and consistent top performing features are selected across all the tenants to create a final list of engineered features which may be included in the training of the ML model.

According to some embodiments of the present disclosure, a system, such as system 100 in FIG. 1 may include common information model training 740. Consortium data, to train the ML model continuously across peer banks by sharing the knowledge across them by using ML model. By this approach, tenants of a service provider, such as banks may gain knowledge from each other's learnings without sharing data between them. XGBoost algorithm may support such continued training. There is a parameter ‘xgb_model’ where the existing model object and model training may be specified to continue from there.

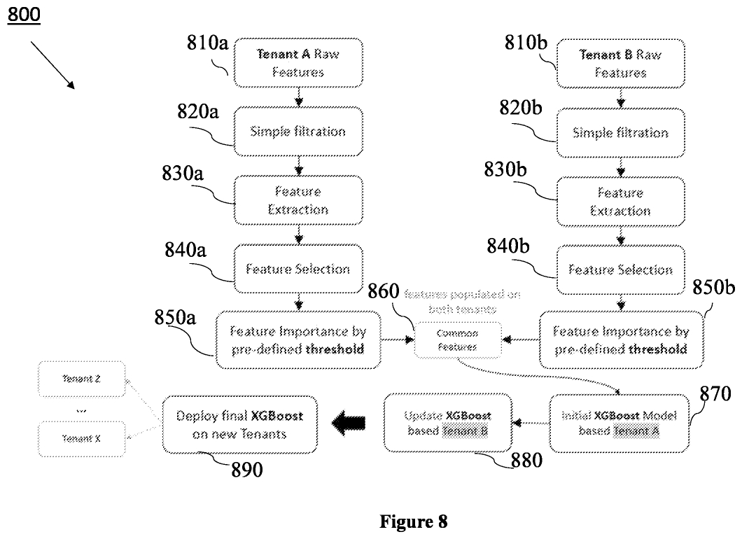

FIG. 8 is a workflow 800 of generating a classification Machine Learning (ML) model, in a cloud-based environment, in accordance with some embodiments of the present invention.

According to some embodiments of the present disclosure, optionally, XGBOOST model may be used to make use of available resources to train the ML model, such as classification ML model 120 in FIG. 1, resulting in more efficient use of time and memory. Some key algorithm implementation features include automatic handling of missing data values and sparse data, block structure to support the parallelization of tree construction, and availability in free opensource software packages. XGBOOST model implementations are available for a variety of platforms, notably Python and R.

According to some embodiments of the present disclosure, three main forms of gradient boosting are supported: (i) classic Gradient Boosting. Sometimes referred to as the “gradient boosting machine”, this approach includes a configurable learning rate. (ii) stochastic Gradient Boosting. Optional parameters allow for sub-sampling at the row, column, and column per split levels; and (iii) regularized Gradient Boosting. Regularization combats overfitting by penalizing proposed solutions that have excessively large coefficients. XGBOOST supports regularization methods based on the sum of the weights squared, or the sum of their absolute values.

According to some embodiments of the present disclosure, XGBOOST also contains facilities for supporting a wide variety of deployment architectures, including parallelized tree construction during training to use all available CPU cores, distributed computing for training very large models using a cluster of machines, out-of-core computing for very large datasets that don't fit into memory, and cache optimization of data structures and algorithm to make the best use of available memory.

According to some embodiments of the present disclosure, the default objective function being minimized by XGBOOST is the following loss function 1:

$${ℒ}^{( t )} = {\sum }_{i = 1}^{n} l ( {y}_{i} , {{\hat{y}}_{i}}^{( t - 1 )} + {f}_{t} ( {x}_{i} ) ) + Ω ( {f}_{t} ) \qquad ( I )$$

whereby:

I is a differentiable convex loss function that measures the difference between the i^{th} prediction at iteration t-1,ŷi^{(t-1)} and the target yᵢ. fᵢ represents the estimated change from t^{th} iteration. Ω penalizes the complexity of the ML model, i.e., the regression tree functions.

The 22, which is an additional regularization term helps to smooth the final learned weights and avoid overfitting. Overfitting is a concept in data science, which describes a situation when a statistical model fits exactly against its training data which means that the model doesn't perform accurately against unseen data, thus, defeating its purpose.

According to some embodiments of the present disclosure, in a system, such as computerized-system 100, in FIG. 1, ‘tenant A’, raw features 810a may be retrieved and then simple filtration 820a may be operated thereon.

According to some embodiments of the present disclosure, the filtered features may go through feature extraction 830a and then feature selection 840a. The selected features may be ordered by feature score based on a predefined threshold 850a. The same process may be operated in ‘Tenant B’ environment 810b-850b and in the rest of the identified tenants to yield common features 860.

According to some embodiments of the present disclosure, in a system, such as computerized-system 100, in FIG. 1, training a ML model, such as classification ML model 120 in FIG. 1, to classify objects on each retrieved dataset corresponding to a tenant from the one or more tenants. The training of the ML model is a continuous training where the ML model continues training after each dataset. For example, initial XGBOOST model based in the environment of ‘Tenant A’ 870. Then, updating the object of the trained ML model in the environment of ‘Tenant B’ 880 and then in the same manner in the environments of the other identified tenants based on the base activity.

According to some embodiments of the present disclosure, deploying the trained ML model in a target tenant system to classify objects. For example, deploying a final XGBOOST on new tenants 890 systems. The target tenant system has no training dataset and no feasible training thereon.

According to some embodiments of the present disclosure, a system such as system 100 in FIG. 1, may leverage a machine learning algorithm, e.g., classification ML model 120 in FIG. 1, such as XGBoost by training the ML model on a dataset having detected one or more common features which has been retrieved from a database 130a in FIG. 1 of bank A, e.g., ‘tenant 1’ 110a in FIG. 1 in its environment and then send the object of the trained ML model to bank B, e.g., ‘tenant 2’ 110b in FIG. 1 and continue training the ML model on a dataset having detected one or more common features which has been retrieved from a database 130b in FIG. 1 in the environment of bank B. Then, send the object of the ML model to the environment of bank C and continue training the ML model in the environment of bank C on a dataset having detected one or more common features which has been retrieved from a database in bank C and so on till bank N.

According to some embodiments of the present disclosure, the trained ML model may be deployed in a target tenant system to classify objects, where the target tenant system has no training dataset and no feasible training thereon and may be operated right from the start i.e., day one to predict fraud transactions such as person to person transfer.

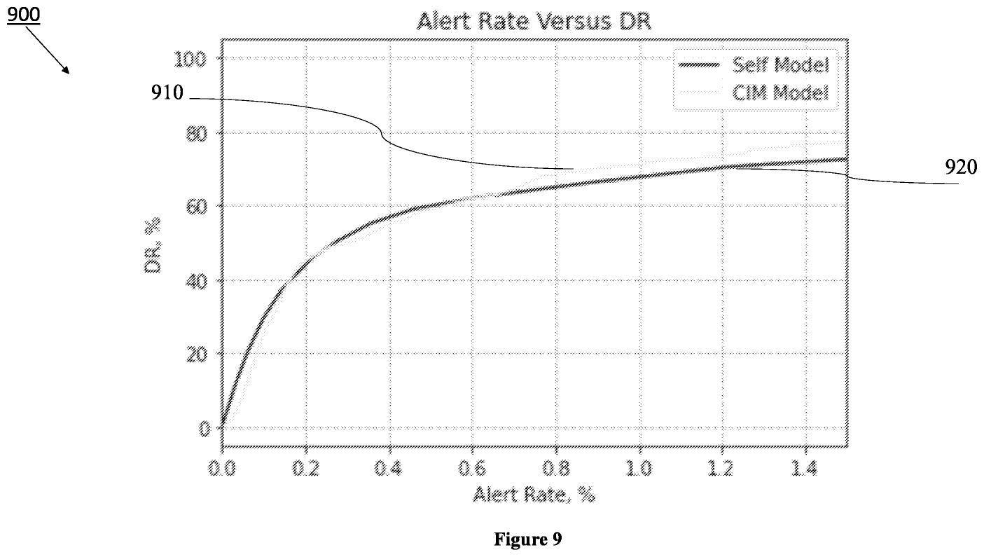

FIG. 9 shows a graph 900 illustrating evaluation and results, in accordance with some embodiments of the present invention.

According to some embodiments of the present disclosure, Detection Rate (DR) is the cumulative percentage of the volume of fraudulent transactions detected by the model out of the total volume of the fraudulent transactions in population. Alert Rate is the proportion of alerted transactions out of the entire transaction population.

According to some embodiments of the present disclosure, the performance of Collective Information Model (CIM) model 910 versus a self model 920 which has been trained on tenant's own data with respect to detection rate. Graph 900 show that the CIM model 910 outperforms the self model 920.

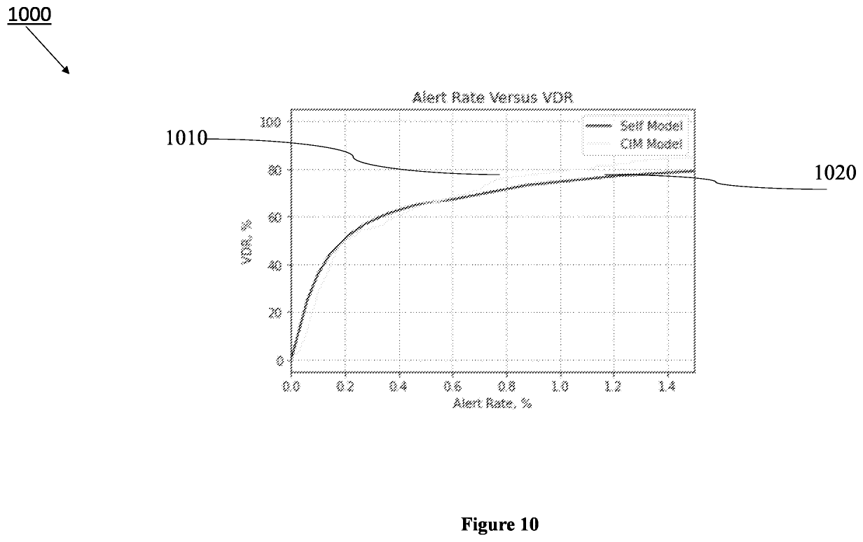

FIG. 10 shows graph 1000 illustrating evaluation and results, in accordance with some embodiments of the present invention.

According to some embodiments of the present disclosure, graph 1000 shows the performance of a Collective Information Model (CIM) model 1010, which is a ML model, such as classification ML model 120, in FIG. 1, versus performance of a model, such as self model 1020 that has been trained on tenants own data, i.e., historical data. The data in the graph shows that the CIM model 1010 outperforms the self model 1020. For example, on the graph at 1% alert rate CIM model detection rate is almost 80% and the self model detection rate is ˜77%.

According to some embodiments of the present disclosure, Value Detection Rate (VDR) is the cumulative percentage of the monetary amount from fraudulent transactions detected by the model out of the total (monetary) amount of the fraudulent transactions population. Alert Rate is the proportion of alerted transactions out of the entire transaction population.

According to some embodiments of the present disclosure, graph 1000 shows that a high-quality model may be generated without compromise on the model's quality even when the model has been developed using collective data from other tenants and not the tenant own dataset only.

According to some embodiments of the present disclosure, the performance of the CIM model 1010 should be either better than the performance of self-model 1020 or at least align with the self-model 1020. Graph 1000 shows that for example, when the alert rate is of 0.6% results it may align and for higher alert rate the CIM model 1010 performs better than the self-model 1020.

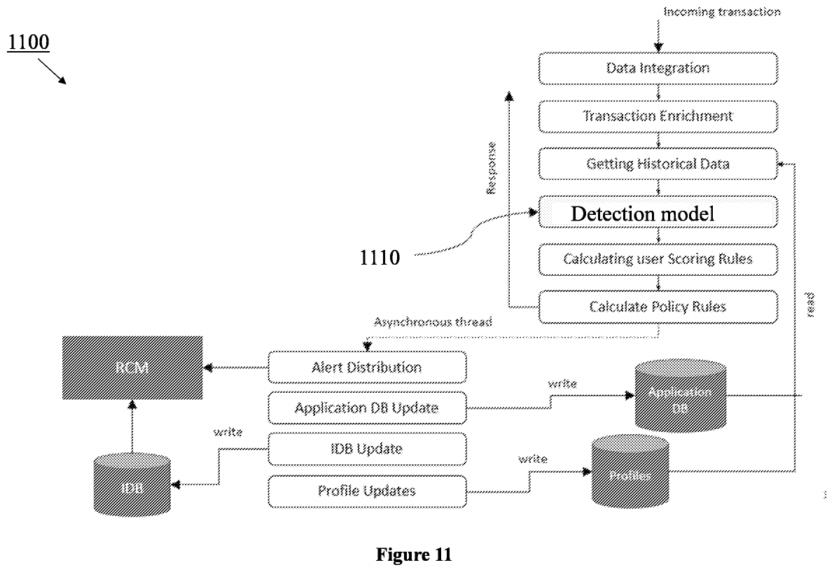

FIG. 11 is a high-level process flow diagram of a system 1100, in accordance with some embodiments of the present disclosure.

According to some embodiments of the present disclosure, a fraud-detection ML model, such as classification ML model 120 in FIG. 1 that is operating in a finance-system in production-environment, may be deployed in a detection model, such as detection model 1110.

According to some embodiments of the current disclosure, system 1100 includes incoming financial transactions into a data integration component which is operating an initial preprocess of the data. Transaction enrichments is the process where preprocess of the transactions happen. The process of getting historical data synchronizes with new incoming transactions. It is followed by the detection model 1110 after which, each transaction gets its risk score for being fraud.

According to some embodiments of the current disclosure, analysts can define calculated variables using a comprehensive context, such as the current transaction, the history of the main entity associated with the transaction, the built-in models result etc. These variables can be used to create new indicative features. The variables can be exported to the detection log, stored in IDB and exposed to users in user analytics contexts.

According to some embodiments of the current disclosure, a policy calculation treats the transactions having a high-risk score i.e., suspicious scores and routes it accordingly. Profiles contain aggregated financial transactions according time period. Profile updates synchronize according to new created or incoming transactions. Customer Relationship Management (CRM) is a system where risk score management is operated: investigation, monitoring, sending alerts, or marking as no risk.

According to some embodiments of the current disclosure, Investigation Data Base (IDB) system is used when research transactional data and policy rules resulting for investigation purposes. It analyzes historical cases and alert data.

According to some embodiments of the current disclosure, financial transactions that satisfy certain criteria may indicate occurrence of events that may be interesting for the analyst. The analyst can define events the system identifies and profiles when processing the transaction. This data can be used to create complementary indicative features (using the custom indicative features mechanism or Structured Model Overlay (SMO)). For example, the analyst can define an event that says: amount >$100,000. The system profiles aggregations for all transactions that trigger this event, e.g., first time it happened for the transaction party etc.

According to some embodiments of the current disclosure, once custom events are defined, the analyst can use predefined indicative feature templates to enrich built-in models results with new indicative features calculations. The analyst can create an indicative feature that says that if it has been more than a year since the customer performed a transaction with amount greater than $100,000 then add 10 points to the overall risk score of the model.

According to some embodiments of the current disclosure, Structured Model Overlay (SMO) is a framework in which the analyst gets all outputs of built-in and custom analytics as input to be used to enhance the detection results with issues and set the risk score of the transaction.

According to some embodiments of the current disclosure, analytics logic is implemented in two phases, where only a subset of the transactions goes through the second phase, as determined by a filter. The filter may be a business activity.

According to some embodiments of the current disclosure, the detection log contains transactions enriched with analytics data such as indicative features results and variables. The Analyst has the ability to configure which data should be exported to the log and use it for both pre-production and post-production tuning.

According to some embodiments of the current disclosure, the detection flow for transactions consists of multiple steps, data fetch for detection, e.g., detection period sets and profile data for the entity, variable calculations, analytics models consisting of different indicative feature instances, and SMO.

According to some embodiments of the current disclosure, the detection process is triggered for each transaction. However, most of the Analytics logic relates to entities rather than transactions. For example, all transactions for the same entity, for example, party, trigger detection, whilst the detection logic is based on the party activity in the detection period.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure. While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. Computerized-method for generating a classification Machine Learning (ML) model, in a cloud-based environment, said computerized-method comprising:
building an ML model by using different isolated datasets from different environments:
(i) identifying one or more tenants of a service provider by a base activity;
(ii) retrieving a set of features of objects from a database of each identified one or more tenants to detect one or more common features;
(iii) using an object storage service in each tenant's environment to retrieve a dataset having the detected one or more common features;
(iv) training a ML model to classify objects on each retrieved dataset corresponding to a tenant from the one or more tenants, wherein the training of the ML model is a continuous training where the ML model continues training after each dataset;
deploying a trained ML model in a target tenant system to classify objects, wherein the target tenant system has no training dataset and no feasible training thereon.

2. The computerized-method of claim 1, wherein when the target tenant system has accumulated a preconfigured amount of historical data, training the ML model on the historical data.

3. The computerized-method of claim 1, wherein the detecting of one or more common features comprising: (i) running feature engineering and feature selection pipeline on each tenant dataset to yield features scores, wherein a feature score indicates a level of relevance of a feature to classification of objects by the classification ML model; and (ii) identifying a preconfigured number of high scores features across each one or more tenants.

4. The computerized-method of claim 3, wherein the features scores are yielded by an extreme Gradient Boosting (XGB) algorithm.

5. The computerized-method of claim 1, wherein the classification ML model is fraud detection ML model and wherein the objects are transactions.

6. The computerized-method of claim 1, wherein the training of the ML model is performed by operating an eXtreme Gradient Boosting (XGB) algorithm.

7. The computerized-method of claim 5, wherein the retrieved dataset having the detected one or more common features is of transactions from a preconfigured period.

8. The computerized-method of claim 1, wherein the retrieved dataset having the detected one or more common features is a labeled dataset.
